(19) United States
(12) Patent Application Publication
(10) Pub. No.: US 2004/0116022 A1
(43) Pub. Date: Jun. 17, 2004

(54) Durable waterproof composite sheet material

(75) Inventors: John D. Langley, Guntersville, AL (US); Todd R. Carroll, Guntersville, AL (US); Barry S. Hinkle, Guntersville, AL (US); Charles T. Vencill, Grant, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Kappler, Inc.

(21) Appl. No.: 10/677,023

(22) Filed: Oct. 1, 2003

Related U.S. Application Data
(60) Provisional application No. 60/415,341, filed on Oct. 1, 2002.

(51) Int. Cl. B32B 5/26; B32B 27/12

(52) U.S. Cl. 442/289; 442/286; 442/268; 442/319

(57) ABSTRACT

A unique durable waterproof and moisture vapor permeable composite sheet material is described that includes a microporous film or film/nonwoven laminate, that is held in close proximity to one or more layers of strength enhancing fabrics. The disclosed composite sheet material is uniquely designed for use in outerwear, tents, tarps, covers, containment systems and shelters requiring waterproofness and breathability during extended outdoor exposure to rain and other high humidity environments.

### CROSS REFERENCE TO RELATED APPLICATION

This application claims priority from U.S. Provisional application 60/415,341 filed Oct. 1, 2002.

### FIELD OF INVENTION

This invention relates generally to waterproof, breathable composite sheet materials designed primarily for use in reusable outerwear, tents, and covers, and more specifically to a novel cost effective means of introducing these characteristics into fabrics that are otherwise penetrated by liquid water.

### BACKGROUND OF THE INVENTION

Textiles and composite materials designed and configured for outdoor exposure ideally exhibit high degrees of water resistance, good drape and flexibility, appealing aesthetic qualities, dimensional stability, and functional manufacturability. The degree of water resistance exhibited by textiles and composite materials is commonly described as either “water repellent” or “waterproof”.

Water repellency can be satisfactory for short term, intermittent exposures to rain and other high humidity environments. This degree of water resistance is easily and economically achieved using a variety of common fluorocarbon- or silicone-based surface and/or fiber treatments such as Durepl® (Burlington Industries) Zepel® (DuPont), and Sili-Tex® (Sili-Tex). Employed on a wide range of fashion garments and numerous outdoor cover products, water repellent materials have enjoyed widespread acceptance and offer a good balance between cost and functionality for short term intermittent exposures. One benefit of water resistance over waterproofness is that water resistance can typically be achieved while maintaining a high degree of air flow through the textile or composite material. High airflow translates to a high degree of comfort when considering apparel applications. The major disadvantage of these type materials is that they tend to shed water in low or no pressure situations but are easily overcome when used for extended periods of time and in areas of a garment where water can come under pressure such as in the crutch of the arm, or when leaning against a water soaked portion of the garment.

Waterproofness is a level of water resistance that is not achievable through traditional surface treatments and is required for situations involving sustained and dynamic exposure to rain and other high humidity environments as can occur during various sporting activities such as extreme sports, hiking, skiing, hunting, sailing, leisure and commercial fishing etc., as well as in innumerable commercial and industrial applications such as delivery and airline services. Water resistant materials have little application in these situations where high and dynamic activity levels are combined with long-term outdoor exposure to potentially harsh (i.e., wet) environments. The “shedding” characteristics exhibited by water resistant textiles and composites are quickly overcome in these scenarios.

The characteristic of waterproofness has been successfully engineered into numerous textile and composite materials using a variety of coatings, films, and membranes. These approaches can be classified as non-breathable in the case of textiles coated with or laminated to films of polyvinyl chloride, neoprene, acrylic, and certain polyurethanes, or as breathable, in the case of various monolithic and microporous films and coatings. Waterproof composites that also exhibit breathability are especially useful in wearing apparel. Finding widespread acceptance, waterproof/breathable textiles and composites have been or are still commercially available that employ both monolithic and microporous films, coatings and membranes comprised of polyethylene, polypropylene, perfluoroethylene, polyamides, urethanes, cellulose-based polymers, etc. Commercial examples of these include Biochitam® (Asahi Chemical Ind.), Breathe® 2000 (UCB Chemicals Corp.), Dermoflex® (Consoltex, Inc.), Drycoat® 85 (MontBell America), Entrant® (Toray Ind.), Ultrex® (Burlingon Industries), Gore-Tex® (W.L. Gore), ThinTech® (3M), and Sympatex® (Elf Akzo).

While the above mentioned textiles and composite materials exhibit waterproofness and varying degrees of breathability (i.e., moisture vapor transmission according to ASTM E96), they do so at a premium price that is not affordable to the general masses within the consumer or industrial markets. The majority of general industrial applications still rely on low cost PVC outerwear due to a balance in strength, durability, waterproofness, visibility, and cost. While waterproof/breathable composites exist such as Gore-Tex® and Sympatex®, these come at a high cost that is not affordable for most large facilities and operations where hundreds if not thousands of garments are required.

Gore-Tex® is based on expanded polytetrafluoroethylene as described by Gore et al. U.S. Pat. No. 4,194,041. Gore describes a waterproof/breathable composite textile material that while functional, comes at a premium cost since it is based on an expensive hydrophobic membrane (i.e. PTFE), and a costly manufacturing technique (i.e., coating/lamination using a hydrophilic polyether-polyurethane). A premium product, Blauer describes several uses of the Gore technology in composites and shells that combine the expanded PTFE with various woven and knitted textile materials. Blauer et al. U.S. Pat. No. 6,336,221 describes a well styled, single layer shell jacket comprising a waterproof, windproof and vapor permeable membrane sandwiched between a woven outer layer and a knit backing. The membrane of which is based on Gore's expanded PTFE and an oleophobic polyurethane coating. In a separate patent, U.S. Pat. No. 5,593,754, Blauer describes another waterproof/breathable composite based on a microporous membrane of PTFE and urethane laminated to various traditional textile materials.

Lim, in U.S. Pat. No. 6,410,465 discloses several other types of waterproof/breathable films and membranes such as copolyesterether ester block copolymers such as Hytrel (DuPont), copolyester amide polymers such as Pebax (Elf Autochem), thermoplastic polyurethanes such as Estane® (B.F. Goodrich Comp.) and copoly(etherimide)esters as described by Hoechst U.S. Pat. No. 4,868,062, which are all equally expensive which has limited their overall usefulness.

As alternatives to the above mentioned approaches, others have attempted to engineer waterproof/breathable textiles and composites using lower cost polyimide and polyolefin-based polymers. Early work in this area borrowed microporous membranes that were otherwise being used in the liquid and gas separation industry. Unfortunately, the inherent slow and complex manufacturing techniques, as described by White (U.S. Pat. No. 5,264,166), McCallister et al., (U.S. Pat. No. 5,130,342), and Baurmeister (U.S. Pat. No. 5,743,775), required to produce such microporous films result in end composites that were also high priced and not conducive to high production quantities, and in many cases, did not offer the oleophobic characteristic required for wearing apparel. The majority of liquid and gas separation membranes rely on liquid/liquid and liquid/solid phase separation to create the pores in a microporous film or membrane. White describes the solvent based casting, extraction, and slow air drying processes used to produce these films. While base resin costs are lower for these type films, production restrains have limited the overall success and commercialization of these type products.

It should be evident from the discussion above, that the need exists for a low cost method of inducing waterproofness and breathability into traditional textile and composite materials.

### SUMMARY OF THE INVENTION

The present invention provides a novel and lower cost approach for imparting the characteristics of waterproofness and breathablitiy into textile fabrics that would otherwise be penetrated by liquid water. Rather than relying on films or membranes comprised of expensive fluoro-based resins or solvent-based extraction type membranes, the present invention utilizes low cost, high volume, microporous films and coatings that are finding widespread use and acceptance within the absorbent hygiene and feminine care markets. These low cost films, such as those described by Hoge (U.S. Pat. No. 4,350,655), Sheth (U.S. Pat. No. 4,777,073), Jacoby (U.S. Pat. No. 5,594,070), Weimer (U.S. Pat. No. 5,690,949) Wu (U.S. Pat. No. 5,865,926) and others, rely on high speed processes using a polymer matrix filled with mechanical pore-forming agents. Calcium carbonate is the most common mechanical pore-forming agent used in these microporous films and membranes because of its low cost, inertness, water insolubility, as well as ease of pulverization and processability. While less common, other organic and inorganic mechanical pore forming agents have also been considered such as clays, titanium oxide, siliceous fillers, barium sulfate, zeolites, etc.

The extreme cost restraints imposed by the hygiene market has drastically decreased the cost of mechanical pore-forming agent filled microporous films. Previously utilized primarily in disposable absorbent end-items, these films and membranes find expanded use as a microporous barrier layer in an array of end-use applications pursuant to the present invention. The technical challenges addressed by the present invention in using these primarily polyolefin-based microporous materials lamination of the microporous layer to noncompatible substrates and differential dimensional stability between the textile layers and microporous layer.

The microporous barrier layer is preferably laminated to one or more breathable and durable woven or knitted outer textile fabric layers using lamination techniques such as hot melt adhesives, powder bond adhesives or solvent-based adhesives. Control over differential dimensional stability is maintained by suitable dimensional stabilization pretreatment of the layers and/or by the particular lamination technique employed. This novel use of otherwise disposable microporous films, membranes, and composites, expands their usefulness beyond their traditional boundaries. A significant advantage of this approach is that the waterproof/breathable composite can be used as the exterior layer allowing for the protection of inner thermal insulative layers in for example garment applications, and end items can be made completely waterproof/breathable by utilizing waterproof/breathable seaming tapes.

Numerous embodiments of the disclosed invention have been conceived to demonstrate the potential breadth and significance of the present invention. Inclusion of these embodiments in no way serves to limit the potential breadth and applicability of the disclosed invention to other configurations and or uses. In general, durable waterproof breathable composite fabrics according to the present invention comprise an outer shell layer formed of a woven or knitted fabric having exterior and interior surfaces, and a microporous barrier layer positioned adjacent the interior surface of said outer fabric and comprising a thermoplastic polymer film containing a mechanical pore-forming agent that renders the film microporous and permeable to moisture vapor. The composite fabrics may optionally include one or more additional layers, such as an inner fabric layer and/or intermediate layers. The outer shell layer is laminated to the microporous barrier layer. Suitable lamination techniques include thermal bonding, ultra-sonic bonding, hot melt adhesive bonding, pressure sensitive adhesive bonding, and powder-bond adhesive bonding. The microporous moisture vapor permeable barrier layer can take any of several forms, such as a free standing microporous thermoplastic film or a microporous thermoplastic polymer film adhered to a nonwoven support substrate. The outer shell fabric layer of woven or knitted material may be comprised of synthetic fibers including nylon, polyester, acrylic, acetate, rayon, polyamides, polypropylene, polyethylene, flame resistant fibers including PBI fibers and meta-aramides and para-aramides such as Kevlar® and Nomex®, natural fibers including cotton, jute, hemp, ramie, and blends of one or more of the foregoing. It can include various fiber deniers, warp and fill counts, as well as fiber, yarn, and/or fabric finishers, treatments and/or additives, such as a waterproof surface treatment, as well as oleophobic, hydrophobic, and/or hydrophilic additives, treatments and/or finishes, antimicrobials, flame resistant additives, UV additives, stain resistant additives and the like.

### BRIEF DESCRIPTION OF THE DRAWINGS

Having thus described the invention in general terms, reference will now be made to the accompany drawings, which are not necessarily drawn to scale, and wherein:

FIG. 1 is perspective view of a boat covered by a boat cover fabricated from a breathable waterproof composite fabric according to one embodiment of the present invention.

FIG. 2 is a schematic cross-sectional view of the boat cover fabric of FIG. 1.

FIG. 3 is a perspective view of a jacket fabricated from a breathable waterproof composite fabric according to another embodiment of the present invention.

FIG. 4 is a schematic cross-sectional view of the jacket fabric of FIG. 3.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

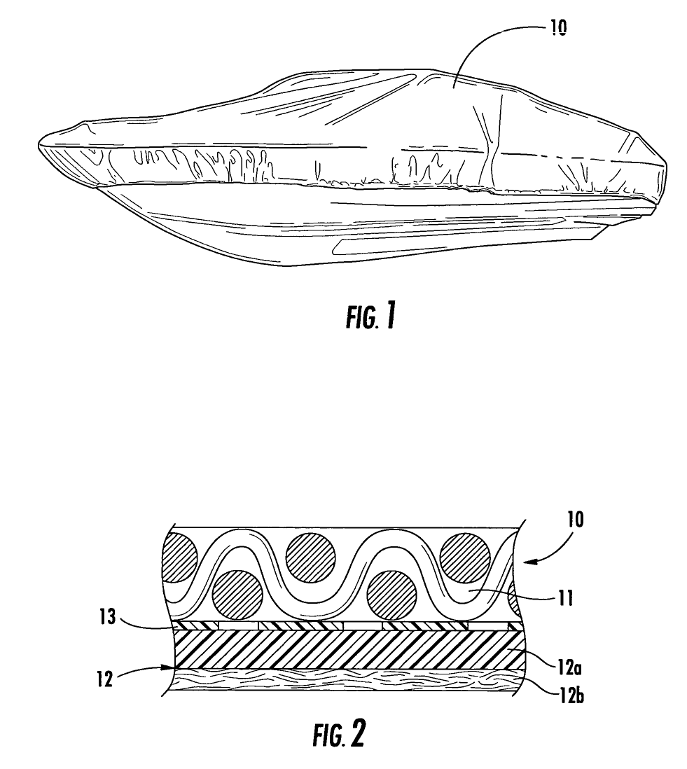

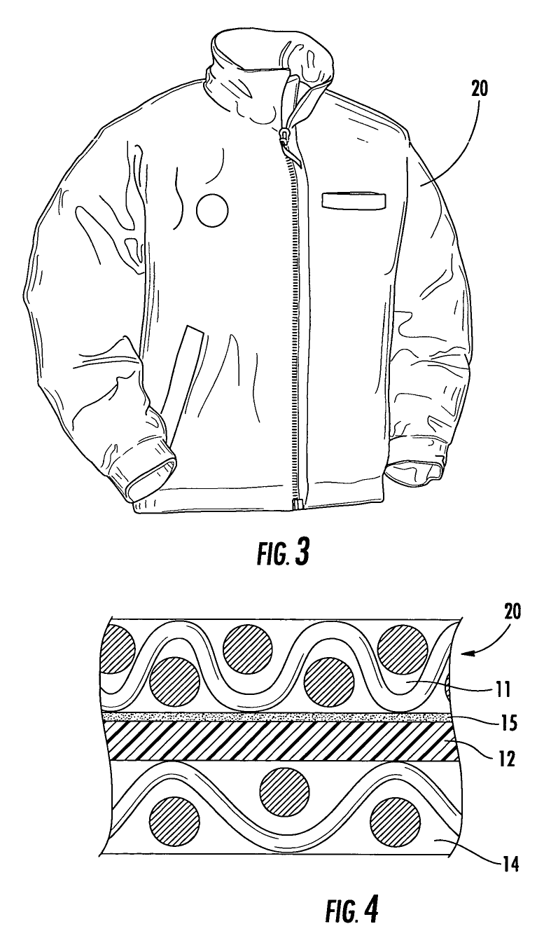

The present invention has application in combining textile fabrics and microporous films or membranes into composites in either bi-, tri-, or other multi-layered construction using various lamination techniques. The composite fabrics are designed for use in various outdoor applications requiring a durable waterproof, breathable fabric. Exemplary applications include outerwear, tents, tarps and covers. FIG. 1 illustrates a boat that has been covered by a boat cover fabricated from a composite breathable waterproof fabric 10 in accordance with the present invention. As seen in greater detail in FIG. 2, the boat cover fabric 10 includes an outer shell fabric layer 11 and a microporous barrier layer 12 laminated to the outer shell fabric by a discontinuous adhesive layer 13. The microporous barrier layer 12 can take several forms, but in the embodiment illustrated it is a film/nonwoven fabric composite formed by extrusion coating a film 12a of thermoplastic polyethylene polymer containing a high loading of calcium carbonate pore-forming agent onto a spunbond nonwoven fabric supporting substrate 12b. The film/nonwoven composite barrier layer 12 is then stretched to cause cavitation to occur around the particles of calcium carbonate pore-forming agent, thereby rendering the film layer 12a microporous and permeable to water vapor.

FIG. 3 illustrates a jacket fabricated from a composite breathable waterproof fabric 20 in accordance with a further embodiment of the present invention. The jacket fabric 20 includes an outer shell fabric 11, a microporous barrier layer 12 laminated to an interior surface of the outer shell fabric by a thermoplastic heat-activatable powder adhesive 15, and an inner fabric layer 14 positioned overlying the interior surface of the microporous barrier layer 12. In the embodiment illustrated, the inner fabric layer 14 is a tricot knit mesh fabric, and it is secured to the barrier layer fabric 12 by rows of stitching (not shown) along the seams of the garment. Although the barrier layer 12 can be produced by any of the various methods described herein, in the illustrated embodiment the barrier layer is a free-standing polyolefin film produced generally in accordance with the process described in Jacoby U.S. Pat. No. 5,594,070.

The outer shell fabric 11 is an outermost layer that provides protection from rain, snow, wind and sun, as well as physical protection against abrasion and the like. To achieve this protective function, the fabric is of a tightly woven or knitted construction. Particularly suitable are woven shell fabrics having a thread count in at least one of the warp and fill direction of 25 yarns per inch or greater. The fabric can be made from natural or synthetic fibers such as nylon, polyester, acrylic, acetate, rayon, polyamides, polypropylene, polyethylene, flame resistant fibers including PBI fibers and meta-aramides and para-aramides such as Kevlar® and Nomex®, cotton, jute, hemp, ramie, and blends of one or more of the foregoing. Yarns from which the shell fabric are woven or knitted can be filament yarns or spun yarns, and preferably have a yarn size of from about 50 to 350 decitex. The fabric preferably has a weight of from about 50 to 350 grams per square meter.

The outer shell fabric can be treated with various additives, surface treatments and/or yarn or fabric finishes to impart desirable performance characteristics. These additives, surface treatments and/or finishes can include, but are not limited to oleophobic, hydrophobic, and/or hydrophilic compositions anti-microbials, flame resistant compositions, anti-static compositions, UV stabiliziers and/or absorbers, stain resistant compositions, adsorptive compositions, reflective or luminescent compositions, reactive compositions, enzymes, etc. The fabric can have varying degrees of water repellency depending upon the specific end use.

Microporous barrier layers in accordance with the present invention are produced from a thermoplastic polymeric resin material that is capable of being heated to a molten or flowable state and extruded in the form of a substantially continuous film. Suitable polymeric resin materials may be selected from the group consisting of polyolefins, polyolefin copolymers, polyesters, polyamides, and blends of these materials. Particularly preferred polyolefin compositions include polypropylene, copolymers of propylene with ethylenically unsaturated monomers such as ethylene, high-density polyethylene, medium density polyethylene, and linear low density polyethylene.

The thermoplastic polymer resin material is blended with one or more mechanical pore-forming agents. The amount of mechanical pore-forming agent present in the blend may be varied, depending upon the degree of porosity desired in the membrane. Preferably, however, the pore-forming agent constitutes at least 5% by weight, and for some applications preferably from 40 to 90 weight percent of the blend. The pore-forming agent and the resin material are blended together to form a homogeneous mixture, either in a preliminary compounding step or directly in a suitable mixing extruder. Examples of mechanical pore-forming agents include clay, calcium carbonate, barium sulfate, magnesium carbonate, magnesium sulfate, alkaline earth metals, baking soda, activated alumina, silica, activated carbon or charcoal, calcium oxide, soda lime, titanium dioxide, aluminum hydroxide, ferrous hydroxides, diatomaceous earths, borax, acetyl salicylic acid, molecular sieves, zeolites, ion exchange resins, talc, kaolin, barium carbonate, calcium sulfate, zinc oxide, calcium oxide, mica, glass, wood pulp, and pulp powder, and mixtures of the foregoing.

The microporosity of the barrier layer film or membrane results from cavitation around the pore-forming agent as induced by incremental stretching, mono- or bi-axial stretching, compression stretching, or other techniques known in the art. Preferably, the microporous barrier layer should have a moisture vapor transmission rate (MVTR) of at least 100 g/m²·24 hr., and more preferably at least 300 g/m²·24 hr when measured by ASTM E96 procedure B at 73° F. and 50% relative humidity. The microporous layer can be in the form of a coating applied directly on to the outer shell fabric, or as a free film or film/nonwoven composite that is subsequently laminated to the outer shell using the techniques listed below, the nonwoven layer being comprised of polyethylene, polypropylene, bicomponent fibers, nylon, polyester, cotton, cellulose, and/or blends thereof. The film, membrane or coating can include other various additives to induce other desirable performance characteristics. Additives can include, but are not limited to oleophobic, hydrophobic, and/or hydrophilic additives, treatments and/or finishes, anti-microbial additives, treatments and/or finishes, flame resistant additives, treatments, and/or finishes, anti-static additives, treatments, and/or finishes, UV additives, treatments, and/or finishes, stain resistant additives, treatments, and/or finishes, adsorptive additives, treatments, and/or finishes, reflective additives, treatments, and/or finishes, luminescent additives, treatments, and/or finishes, reactive additives, treatments, and/or finishes, enzyme additives, treatments, and/or finishes, antioxidants, stabilizers, UV absorbers, and enzymes.

The microporous membrane of the present invention can take the form of an unsupported or “free-standing” film, or the membrane can be combined with one or more other layers to form a microporous composite. The microporous membrane or composite can be manufactured in accordance with any of a number of manufacturing processes known in the art for producing microporous films and composites, such as those described in the below-mentioned United States patents, the disclosures of which are hereby incorporated by reference.

For example, an unsupported microporous free-standing film membrane can be produced generally in accordance with the teachings of Jacoby U.S. Pat. No. 5,594,070 by extruding a thermoplastic polymer composition containing mechanical pore-forming agents in the form of filler materials and a beta-spherulite nucleating agent from a slot die to form a film, allowing the extruded continuous film to cool and solidify, subjecting the film to an extracting step to extract beta-spherulites, and subsequently stretching the thus formed film uniaxially or biaxially, thereby producing a film having microscopic pores throughout. The microscopic pores impart breathability to the film. Suitable microporous membranes or films can also be produced without the extraction step. For example, following the teachings of the Hoge U.S. Pat. No. 4,350,655, a thermoplastic polymer composition blended with calcium carbonate in finely divided particulate form can be extruded from a slot die to form a film, and can be subsequently stretched, with or without embossing, to form the microporous film membrane. Similarly, a process similar to that described in Sheth U.S. Pat. No. 4,777,073 can be utilized to form a microporous film membrane from a blend of polypropylene or polyethylene and calcium carbonate. In this process, a continuous film is extruded from a slot die and his subsequently embossed with a pattern to embossing roller. The embossed film is subsequently cold stretched, imparting microporosity to the film.

In yet another approach, a microporous membrane material can be produced generally in accordance with the teachings of Weimer et al. U.S. Pat. No. 5,690,949. In this process the thermoplastic polymer material is blended with a mineral oil in addition to the calcium carbonate filler. Upon cooling of the thermoplastic polymer composition, a phase separation occurs between the polymer compound and the processing oil.

In still another embodiment, a microporous membrane composite material can be produced by extrusion coating a film or layer of a microporous formable composition containing a thermoplastic polymer and mechanical pore-forming agent onto a nonwoven fabric reinforcing substrate material to form a continuous film on the reinforcing substrate. The film/nonwoven substrate composite is subsequently stretched to render the composite microporous. A process similar to that described in Wu et al. U.S. Pat. No. 5,865,926 can be suitably employed.

The breathable microporous barrier layer and the durability enhancing outer shell layer or layers are preferably laminated using lamination techniques known in the art, including either hot melt adhesives such as polyester-based copolymer powder bond adhesives or solvent-based polyurethane adhesives, commercial examples of which are available from EMS-Griltech (Sumter, S.C.), H.B. Fuller (St. Paul, Minn.), and Rohm and Haas (Philadelphia, Pa.).

Gore (U.S. Pat. No. 4,194,041), Norvell (U.S. Pat. No. 4,868,928), Schultze (U.S. Pat. No. 6,001,464), Dutta (U.S. Pat. No. 5,894,011) and others all expand on the common practice of utilizing various polyurethane-based materials as the adhesive layers when combining microporous membranes with traditional textile fabrics in durable waterproof/breathable composites. Polyurethane can be engineered to adhere to a variety of desirable outer and inner shell materials such as polyester, nylon, acrylic, rayon, polyaramides, cotton, and blends thereof. In many cases, the polyurethane contributes highly to the overall waterproofness of the final composite. The adhesion characteristics of polyurethane are strong enough to allow for a high degree of process flexibility and application techniques. Solvent-based polyurethane adhesives can be effectively used, especially when applied in a discontinuous manner, such as by gravure roll coating. Pressure sensitive adhesives can be also used, and certain grades of pressure sensitive adhesives, such as acrylic pressure sensitive adhesives developed for medical applications, exhibit breathability and can be applied in a continuous manner to bond the layers together. Hot melt and thermally activatable adhesives can also be used, but care must be exercised not to overheat the layers to the point that the micropores of the microporous barrier layer are closed: or that the integrity of the barrier layer is compromised. When using powder-bond adhesives, the breathability of the composite fabric is maintained by using the minimum amount of powder adhesive that will achieve adequate lamination strength, and by controlling the temperature and residence time when thermally activating the powder adhesive.

From the foregoing, it is evident that the lamination techniques are intended to provide an effective strong bond between the outer shell fabric layer and the microporous barrier layer, as well as other layers, while maintaining the breathability of the composite fabric laminate. The composite fabric laminate should have a moisture vapor transmission rate (MVTR) of at least 100 g/m²·24 hr., and more preferably at least 300 g/m²·24 hr when measured by ASTM E96 procedure B at 73° F. and 50% relative humidity.

Major differences may exist in the dimensional stability of polyolefin-based microporous films and composites as compared to traditional textiles such as nylon, polyester, acrylic, rayon, polyaramides, cotton, and blends thereof. The present invention allows for flexibility in the level of adhesion and dimensional stability as determined by the performance and aesthetic requirements of the end product application. For example, a composite engineered for use in reusable outwear should exhibit greater dimensional stability since it is ideally reusable (i.e., launderable), whereas a waterproof/breathable boat cover would not necessarily require the same level of dimensional stability.

If the dimensional stability of each separate layer in the composite is similar, the percentage area of adhesion can be lower and still result in a final composite that maintains its dimensional stability after laundering. Conversely, if the dimensional stability of the layers on the present invention is dissimilar, then the percentage area of adhesion must be increased to maintain the overall stability of the composite after laundering. However, differences in dimensional stability and percent area of adhesion can also be used under the present invention to impart varying degrees of “puckering” for aesthetic purposes. Other more complex approaches have been used to impart puckering such as that described by Mueller U.S. Pat. No. 4,108,597. Rather than using the costly and degredative thermal and chemical treatments described by Mueller, the present invention relies on the inherent stability characteristics of composite layers and the percentage area adhesion to control the degree of shrinkage retained in the final composite structure. This unexpected result of the present invention obviously has application in the fashion market for waterproof breathable apparel.

Important to this application is the control of dimensional stability which can be achieved via pre-shrinking of one or more of the composite layers using techniques commonly know in the art, by utilizing various chemical treatments such as immersion in various caustic or formaldehyde-based solutions as described by Hendrix (U.S. Pat. No. 4,396,390) which is incorporated herein by reference, or by controlling the percentage area of adhesion as described earlier. Maximum dimensional stability is achieved by matching the dimensional stability characteristics of each layer in the composite to ensure a flat composite after laundering, or increasing the percentage of adhered area between the microporous layer and the textile layer(s) thus restricting independent movement of the layers which has also been shown under the present invention to result in an overall dimensionally stable composite.

As discussed above, the dimensional stability exhibited by the final waterproof/breathable composite material is controlled by pre-shrinkage of one or more of the outershell and/or microporous layers, chemical treatment of one or more layers to reduce shrinkage, and/or by controlling the percentage area adhesion, applicable lamination techniques including ultra-sonics, thermal, low melt adhesive webs and fusible adhesives as described by Simon (U.S. Pat. No. 5,110,673) which is incorporated herein by reference, pressure sensitive adhesives, powder-bond adhesive as described by Zimmerman (U.S. Pat. No. 4,845,583), which is incorporated herein by reference, hot-melt adhesives, extrusion lamination, etc. with percentage area adhesion being from less than 10% to 100% (i.e., complete coverage).

This novel use of otherwise non-environmentally stable breathable microporous films and membranes expands their usefulness beyond their traditional boundaries. In the non-limiting examples which follow, several specific embodiments of the disclosed invention described. Inclusion of these embodiments in no way serves to limit the potential breath and applicability of the disclosed art to other configurations and or uses.

### EXAMPLES

### Example 1

A waterproof breathable bi-laminate composite was fabricated using one layer of a 136 gram per square meter (gsm) (4 ounce per square yard) woven microdenier polyester fabric formed of 75 denier (82 dtex) yarns containing 150 filaments per yarn and having a fabric count of about 65×65 yarns per inch (26×26 threads per cm) and one layer of an approximately 35 gsm calcium carbonate-filled polyolefin low density polyethylene (LDPE) breathable microporous film produced according to Wu (U.S. Pat. No. 5,865,926). These layers were laminated by applying between 10 and 25 gsm of a copolyester-based powderbond adhesive (EMS-Griltex) to one surface of the polyester fabric layer and heating the adhesive to above its softening point by bringing the adhesive laden textile through an oven set to 121 to 191° C. (250-375° F.) and at a speed of between 15-40 meters per minute (50-125 fpm). The breathable microporous polyolefin film was brought in contact with the adhesive laden polyester fabric directly after the oven by way of a nip, the pressure of which was set at a level to achieve sufficient bond. The resulting bi-laminate composite had a basis weight of 183 gsm (5.4 osy) per ASTM D751, and a moisture vapor transmission rate of approximately 523 g/m²-24 hr. when tested in accordance with ASTM E96, procedure B at 73° F. and 50% relative humidity.

### Example 2

A waterproof breathable bi-laminate composite was fabricated using one layer of an 271 gsm (8 osy) solution dyed acrylic having a fabric count of approximately 25×25 yarns per inch (10×10 yarns per cm) available under the trademark Outdura (Hickory, N.C.) and one layer 75 gsm (2.2 osy) of a bi-laminate microporous composite. The microporous composite consisting of 30 gsm of calcium carbonate-filled LDPE extrusion coated onto a 51 gsm (1.5 osy) spunbonded polypropylene nonwoven which was subsequently incrementally stretched according to Wu U.S. Pat. No. 5,865,926 These layers were laminated by applying between 10 and 25 gsm of the polyethylene-based powdered adhesive Microthene® G (Equistar, Houston, Tex.) to one surface of the acrylic layer and heating the adhesive to above its softening point by bringing the adhesive laden textile through an oven set to 121 to 191° C. (275-350° F.) and at a speed of between 15-40 meters per minute (50-125 fpm). The microporous composite was brought in contact with the adhesive laden acrylic directly after the oven by way of a nip, the pressure of which was set at a level to achieve sufficient bond. The resulting bi-laminate composite had a basis weight of 369 gsm (10.9 osy) per ASTM D751, a destructive peel strength when tested in accordance with ASTM D751, and a moisture vapor transmission rate of approximately 314 g/m²-24 hr when tested in accordance with ASTM E96 procedure B. Upon washing, the composite exhibited a dimensional stability of md/xd (%) of 3.1/1.0.

### Example 3

A sample similar to Example 1 was fabricated with the exception that the breathable composite was replaced with a 45.7 μm (1.8 mil) free-standing polypropylene-based calcium carbonated-filled breathable microporous film produced according to Jacoby (U.S. Pat. No. 5,594,070), available under the trademark Aptra® AP3 (RKW USA, Rome, Ga.), and the polyester adhesive was replaced with the Equistar Microthene® adhesive used in Example 2. The resulting bi-laminate composite had a basis weight of 159 gsm (4.7 osy) per ASTM D751, a peel strength of 63.2 g/cm (160.5 gms/in) when tested in accordance with ASTM D751, and a moisture vapor transmission rate of approximately 718 g/m²-24 hr when tested in accordance with ASTM E96. Upon washing, the composite exhibited a dimensional stability of md/xd (%) of 4.2/2.1.

### Example 4

A sample similar to Example 3 was fabricated except that the polypropylene Jacoby-type breathable microporous film was replaced with a polyethylene Wu-type breathable microporous film. The resulting bi-laminate composite had a basis weight of 190 gsm (5.6 osy) per ASTM D751, a peel strength of 270.7 gms/in when tested in accordance with ASTM D751, and a moisture vapor transmission rate of approximately 673 g/m²-24 hr when tested in accordance with ASTM E96. Upon washing, the composite exhibited a dimensional stability of md/xd (%) of 5.2/1.

### Example 5

A tri-laminate embodiment was fabricated using a 136 gsm (4.0 osy) nylon Taslan outer shell fabric with a fabric count of 50×60 yarns per inch, the polyethylene-based Wu-type film described above in Example 1, and an additional backside shell consisting of a 51 gsm (1.5 osy) knitted nylon fabric. The tri-laminated was fabricated similar to Example 3 using the same Microthene polyethylene-based powdered adhesive, with the adhesive being applied in similar fashion to the nylon fabrics in succession. The resulting tri-laminate composite had a basis weight of 254 gsm (7.5 osy) per ASTMD751, peel strength of 514 gms/in on the front side and 166 gms/in on the backside when tested in accordance with ASTM D751. The composite also exhibited a moisture vapor transmission rate of 703 g/m²-24 hr when tested in accordance with ASTM E96.

### Example 6

A further bi-laminate composite was fabricated as in Example 3, with the exception that the powder bond adhesive process was replaced with a discontinuous layer of a solvent-based urethane adhesive, application weight and lamination conditions being those commonly know in the art such as described by Gore (U.S. Pat. No. 4,194,041) and Blauer (U.S. Pat. No. 5,593,754). In this example the 136 gsm (4 osy) microdenier polyester was laminated to a free standing Jacoby-type polypropylene microporous film.

### Example 7

Similar to Example 6, a tri-laminate composite was fabricated by laminating an additional layer of a 51 gsm (1.5 osy) knitted polyester fabric to the back side of the microporous film using the same solvent-based adhesive as described above.

### Example 8

A further example was fabricated using a breathable medical grade acrylic-based pressure sensitive adhesive, MD1136, available from Avery Dennison (Painesville, Ohio). Bi-laminate examples were fabricated using the Nylon, polyester, and solution dyed acrylic fabrics described above as well as a standard woven cotton/polyester blend. These outer shell materials were laminated to the Wu-based microporous composite described under Example 1 using 15-40 gsm of the MD1136 adhesive. Minimal shrinkage was measured on these samples after machine washing. The composite fabric had a moisture vapor transmission rate of approximately 276 g/m²-24 hr under ASTM E96, procedure B.

### That which is claimed is:

1. A durable waterproof breathable composite fabric comprising an outer shell fabric layer formed of a woven or knitted fabric having exterior and interior surfaces, and a microporous barrier layer positioned adjacent the interior surface of said outer fabric and comprising a thermoplastic polymer film containing a mechanical pore-forming agent that renders the film microporous and permeable to moisture vapor.

2. The composite fabric of claim 1, wherein the outer shell fabric layer is laminated to the microporous barrier layer.

3. The composite fabric of claim 2, wherein the process of lamination is selected from the group consisting of: thermal bonding, ultra-sonic bonding, hot melt adhesive bonding, pressure sensitive adhesive bonding, solvent based adhesive bonding and powder-bond adhesive bonding.

4. The composite fabric of claim 2, wherein the outer shell fabric layer and the microporous barrier layer are laminated at discrete spaced apart locations.

5. The composite fabric of claim 4, wherein the percentage area of adhesion is between 10% and 100%.

6. The composite fabric of claim 1, wherein the thermoplastic polymer film is a free-standing film.

7. The composite fabric of claim 1, wherein the thermoplastic polymer film is adhered to a nonwoven support substrate.

8. The composite fabric of claim 7, wherein the support substrate is a spunbond nonwoven fabric.

9. The composite fabric of claim 8, wherein the spunbond nonwoven fabric is comprised of bicomponent fibers.

10. The composite fabric of claim 1, wherein the microporous barrier layer is a thermoplastic polymer film extrusion coating applied directly to the interior surface of said outer shell fabric.

11. The composite fabric of claim 1, wherein the moisture vapor transmission rate (MVTR) of the composite fabric is at least 100 g/m²·24 hr. when measured by ASTM E96 procedure B at 73° F. and 50% relative humidity.

12. The composite fabric of claim 1, wherein the outer layer of woven or knitted fabric is comprised of nylon, polyester, acrylic, cotton, rayon, acetate, polyamides, polypropylene, polyethylene, flame retardant fibers and/or blends thereof.

13. The composite fabric of claim 12, wherein the outer layer of woven or knitted fabric is a dimensionally stabilized fabric.

14. The composite fabric of claim 12, wherein the outer layer of woven or knitted fabric includes a waterproof surface treatment.

15. The composite fabric of claim 12, wherein said fabric has a fabric count in at least one fabric direction of 25 yarns per inch or greater.

16. The composite fabric of claim 1, including an inner layer of a woven, knitted, nonwoven or foamed material laminated to said microporous barrier layer.

17. The composite fabric of claim 1, wherein the microporosity of the intermediate layer is produced via stretching the mechanical pore-forming agent filled thermoplastic polymer film.

18. A durable waterproof breathable composite fabric comprising a closely woven or knitted outer shell fabric having exterior and interior surfaces, and a microporous barrier layer laminated to the interior surface of said outer shell fabric, said microporous barrier layer comprising a polyolefin polymer film layer filled with a mechanical pore-forming agent that renders the polyolefin film microporous and permeable to moisture vapor.

19. The composite fabric of claim 18, wherein said outer shell fabric is pre-shrunk to impart dimensional stability.

20. The composite fabric of claim 18; wherein said outer shell fabric is chemically treated to impart dimensional stability.

21. The composite fabric of claim 18, wherein the outer shell fabric and the microporous barrier layer are of equal dimensional stability after laundering thus rendering the composite shrink resistant.

22. The composite fabric of claim 18, wherein the microporous barrier layer includes a spunbond nonwoven fabric supporting substrate bonded to said polyolefin polymer film layer.

23. A durable waterproof breathable composite fabric comprising an outer layer formed of a woven fabric having exterior and interior surfaces, a microporous barrier layer positioned adjacent the interior surface of said outer fabric and comprising a nonwoven fabric supporting substrate formed of polyolefin fibers or filaments and a polyolefin polymer film layer carried by and adhered to said nonwoven fabric supporting substrate, the polyolefin polymer film layer containing a mechanical pore-forming agent that renders the film microporous and permeable to moisture vapor, a moisture vapor permeable adhesive layer bonding one surface of said microporous barrier layer to the interior surface of said outer layer, and an inner fabric layer positioned adjacent the opposite surface of said microporous barrier layer and secured thereto.

24. The composite fabric of claim 23, wherein the inner fabric layer is secured to said microporous barrier layer by an adhesive.

25. The composite fabric of claim 23, wherein the inner fabric layer is secured to said microporous barrier layer by stitching along peripheral edge portions of the composite fabric.

26. The composite fabric of claim 23, wherein the moisture vapor permeable adhesive layer comprises a discontinuous adhesive layer.

27. The composite fabric of claim 23, wherein the moisture vapor permeable adhesive layer comprises a power bond adhesive.

28. A method of making a waterproof, breathable composite fabric which comprises forming a microporous barrier layer from a thermoplastic polymer film containing a mechanical pore-forming agent that renders the film microporous and permeable to moisture vapor, and laminating the microporous barrier layer to an outer shell fabric layer formed of a woven or knitted fabric.

29. The method of claim 28, wherein the step of forming a microporous barrier layer comprises extruding a thermoplastic polymer film containing said mechanical pore-forming agent, and stretching the film to impart microporosity.

30. The method of claim 29, wherein the film is extruded as a free standing film.

31. The method of claim 29, wherein the film is extrusion coated onto a nonwoven fabric supporting substrate.

32. The method of claim 29, including a further step of laminating the microporous film to an additional interior layer of woven, knitted, nonwoven, or foamed materials.

33. The method of claim 29, wherein the stretching is achieved via incremental stretching, intermeshing, inter-digitization, mono-axial stretching, biaxial stretching, compression molding, vacuum molding, or cold rolling.

34. The method of claim 29, wherein the process of lamination is selected from the group consisting of thermal lamination, ultra-sonic lamination, hot melt adhesive bonding, pressure sensitive adhesive bonding, solvent based adhesive bonding and powder-bond adhesive bonding.

35. The method of claim 28, wherein the exterior woven or knitted shell fabric layer and the microporous barrier layer are laminated at discrete and spaced apart locations.

36. The method of claim 35, wherein the percentage area of adhesion is between 10% and 100%.

37. The method of claim 28, including the step of pre-shrinking the outer shell fabric layer to improve the dimensional stability of the composite fabric.

38. The method of claim 28, including the step of chemically treating the outer shell fabric layer to improve the dimensional stability of the composite fabric.

39. The method of claim 28, wherein the composite layers are of equal dimensional stability after laundering thus rendering the composite shrink resistant.

40. The method of claim 28, wherein the composite layers are of unequal dimensional stability after laundering thus allowing the final composite to pucker after laundering.

41. A method of making a waterproof, breathable composite fabric which comprises extruding a thermoplastic polyolefin resin composition containing a mechanical pore-forming agent to form an extruded film, allowing the extruded film to cool and solidify, stretching the film to produce microscopic pores throughout the film that render the film permeable to moisture vapor, and laminating the microporous barrier layer to an outer shell fabric layer formed of a woven or knitted fabric.

42. The method of claim 41, wherein the extruding step comprises extruding an unsupported free-standing film of the thermoplastic polyolefin resin composition and mechanical pore-forming agent, and the stretching step comprises stretching the film uniaxially or biaxiaiiy.

43. The method of claim 41, wherein the extruding step comprises extrusion coating a film of the thermoplastic polyolefin resin composition and mechanical pore-forming agent onto the surface of a nonwoven fabric supporting substrate and forming a composite of the film and substrate, and the stretching step comprises stretching the composite uniaxially or biaxially.

44. The method of claim 41, wherein the laminating step comprises applying a thermoplastic powder adhesive between the microporous barrier layer and the outer shell fabric layer, heating the powdered adhesive to above its softening point, and applying pressure to combine the layers.

45. The method of claim 41, wherein the laminating step comprises applying a hot-melt adhesive between the microporous barrier layer and the outer shell fabric layer and applying pressure to combine the layers.

46. The method of claim 41, wherein the laminating step comprises applying a solvent-based adhesive between the microporous barrier layer and the outer shell fabric layer, and applying pressure to combine the layers.
